(19) United States
(12) Patent Application Publication
(10) Pub. No.: US 2018/0213776 A1
(43) Pub. Date: Aug. 2, 2018

(54) COMPOSITIONS FOR CONTROLLING MOSQUITO POPULATIONS

(71) Applicant: PRESIDENT AND FELLOWS OF HARVARD COLLEGE, Cambridge, MA (US)

(72) Inventors: Evdoxia G. Kakani, Cambridge, MA (US); Flaminia Catteruccia, Cambridge, MA (US); Paolo Gabrieli, Milan (IT); Doug Paton, Somerville, MA (US)

(21) Appl. No.: 15/746,690

(22) PCT Filed: Jul. 22, 2016
(86) PCT No.: PCT/US2016/043669

§ 371 Date: Jan. 22, 2018

Related U.S. Application Data
(60) Provisional application No. 62/195,681, filed on Jul. 22, 2015.

(51) Int. Cl. A01N 37/40; A01M 1/20; A01M 1/02

(52) U.S. Cl. CPC A01N 37/40; A01M 1/106; A01M 1/02; A01M 1/2016

(57) ABSTRACT

Methods are disclosed herein for at least one of (i) substantially reducing Plasmodium and/or oocyst development, (ii) substantially reducing mating success, (iii) substantially abolishing egg development after blood feeding, (iv) substantially reducing the mean survival rate; (v) substantially reducing at least one of the transmission of mosquito borne pathogens; and (vi) substantially reducing the propensity for mosquito biting comprising contacting adult, female mosquitoes with a composition comprising an effective amount of one or more non-steroidal ecdysone agonists. The one or more non-steroidal ecdysone agonists can be comprised indoor or outdoor surface.

### CROSS-REFERENCE TO RELATED APPLICATION

This application claims priority to Provisional U.S. Patent Application Ser. No. 62/195,681, filed Jul. 22, 2015, which is incorporated by reference herein in its entirety.

### BACKGROUND OF THE INVENTION

Despite recent progress in combating the malaria parasite, nearly 200 million people are infected and around 600,000 deaths are recorded every year, mostly young children in sub-Saharan Africa. Besides reducing mortality in areas of high malaria transmission, new goals laid out by the WHO aim to eliminate malaria in low endemicity countries through a combination of interventions targeting both the parasite and mosquito vector. Even with new drugs and vaccines in the pipeline, control of Anopheles mosquitoes that transmit malaria remains the cornerstone of malaria prevention and transmission reduction efforts. Of the four classes of insecticides available for mosquito control, pyrethroids are the only compounds approved for use on long-lasting insecticide-impregnated bed nets (LLINs) due to low toxicity, and are heavily used in indoor residual spraying (IRS) programs. This is a major limitation, as the increased application of both interventions over the last decade has inevitably led to the emergence and spread of insecticide resistance in natural mosquito populations. Indeed, fully susceptible Anopheles populations cannot be found in any African country, making the identification of alternative compounds that are non-toxic to humans and that can reduce disease transmission a high priority in the malaria control agenda.

Insecticide-based interventions impact malaria transmission by increasing the mortality rate of exposed females and, in the case of LLINs, by preventing mosquitoes from biting humans. Mathematical models developed to aid in the design of malaria elimination programs during the first global eradication campaign showed the importance of increasing mosquito mortality, which reduces the probability that mosquitoes survive for the 12-14 day incubation period of the malaria parasite. However, other aspects of mosquito biology that determine vectorial capacity for malaria transmission, such as host preferences for blood-feeding, immune responses to the parasites, and mosquito population densities, have not yet been exploited for malaria control.

Anopheles population densities are driven by the complex mosquito lifecycle involving multiple gonotrophic cycles in fertilized females, who lay hundreds of eggs following successive blood meals. Each egg batch is fertilized by sperm that is stored by the female for her lifetime following a single insemination event. Many of the processes characterizing this reproductive cycle are regulated by 20-hydroxyecdysone (20E), a steroid hormone originally studied in insects for its fundamental role in larval molting. Besides an essential function of female-produced 20E in triggering egg development after blood feeding, in Anopheles gambiae as well as in other important anopheline vector species, sexual transfer of this hormone by the male induces a dramatic series of molecular events that culminate in increased oogenesis, induction of egg laying and loss of the female's susceptibility to further mating.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Based on 20E's multiple physiological effects, the inventors have found that 20E non-ecdysteroidal agonists such as dibenzoylhydrazines (DBHs) can be utilized to manipulate reproductive success and other aspects of mosquito biology that are relevant for vectorial capacity. While not being bound by any specific theory, DBH compounds are believed to mimic the action of 20E by competitively binding to the ecdysteroid receptor, resulting in high ecdysteroid activity. Indeed when provided to larvae, DBHs induce precocious and incomplete molting, leading to death by starvation and desiccation. However, their potential use against adult mosquito stages, those responsible for parasite transmission, has never been tested.

The inventors have shown, for example, that topical application of the DBH compound methoxyfenozide significantly limits the reproductive success of adult An. gambiae females and greatly increases their mortality. Moreover they show that methoxyfenozide impairs the development of Plasmodium parasites in the Anopheles mosquito. In addition, the inventors have incorporated their experimental findings into a mathematical model of the mosquito life cycle to determine the potential impact of the compound on mosquito population dynamics and malaria transmission. They predict that application of DBH in impregnated bed nets or in indoor spray programs would significantly reduce malaria transmission. In their model DBH treatment achieves comparable results to the use of insecticides, and enhances insecticide effectiveness when used in combination, regardless of the level of coverage. They also predict that the impact of DBH on malaria transmission is primarily due to a shift in the mosquito age distribution, such that even when there are a similar number of adult females in the population, the older females capable of transmitting malaria are rare. The use of these steroid hormone agonists against Anopheles mosquitoes therefore provides a new strategy for malaria control.

Embodiments of the present invention are therefore directed to a method for at least one of substantially reducing Plasmodium and/or oocyst development, substantially reducing mating success, substantially abolishing egg development after blood feeding, and substantially reducing the mean survival rate of adult, female mosquitoes. The method comprises contacting the adult, female mosquitoes with a composition comprising an effective amount of one or more non-steroidal ecdysone agonists.

As used herein, the term “substantially reducing Plasmodium and/or oocyst development” generally refers to reducing the number of oocysts per midgut of adult, female mosquitoes by about 50%, about 55%, about 60%, about 65%, about 70%, about 75%, about 80%, about 85%, about 90%, about 95%, about 97%, about 99%, about 100% or from about 50% to about 100% (e.g., from about 60% to about 90%, about 70% to about 99%, about 80% to about 100% or about 90% to about 100%) relative to a control (e.g., methoxyfenozide relative to acetone). An “effective amount of one or more non-steroidal ecdysone agonists” is one that achieves these reductions.

As used herein, the term “substantially reducing mating success” generally refers to reducing the ratio of the percentages of “mated” to “not mated” adult, female mosquitoes from about 7 to about 0.1 (e.g., about 7 to about 0.4, about 6 to about 0.5, about 5 to about 0.4 or about 4 to about 0.4) relative to control (e.g., no DBH relative to DBH). An “effective amount of one or more non-steroidal ecdysone agonists” is one that achieves these reductions. As used herein, the term “mated” includes females that become inseminated during mating and females that, for one reason or another, (e.g., females exposed to DBH treatment) do not become inseminated, even though they have mated.

For example, in a control group, the percentages of mated to not mated adult, female mosquitoes might be 86% and 14%, respectively. And in the DBH group, the percentages of mated to not mated adult, female mosquitoes might be 29% and 71%, respectively. The ratio of the percentages of mated to not mated adult, female mosquitoes in the control group is therefore about 6. And the ratio of the percentages of mated to not mated adult, female mosquitoes in the DBH group is about 0.4. The ratio of the percentages of mated to not mated adult, female mosquitoes has therefore been reduced from about 6 to about 0.4 in the DBH group, relative to the control group.

In some embodiments, the substantially reducing mating success comprises a substantial reduction in number of eggs produced by the adult, female mosquitoes or a substantial reduction in the success of insemination of the adult, female mosquitoes.

As used herein, the term “substantially abolishing egg development after blood feeding” generally refers to reducing egg development in adult, female mosquitoes by about 50%, about 55%, about 60%, about 65%, about 70%, about 75%, about 80%, about 85%, about 90%, about 95%, about 97%, about 99%, about 100% or from about 50% to about 100% (e.g., from about 60% to about 90%, about 70% to about 99%, about 80% to about 100% or about 90% to about 100%) relative to a control (e.g., no DBH relative to DBH). An “effective amount of one or more non-steroidal ecdysone agonists” is one that achieves these reductions.

As used herein, the term “substantially reducing the mean survival rate” generally refers to reducing the survival rate of adult, female mosquitoes after 14 days by about 50%, about 55%, about 60%, about 65%, about 70%, about 75%, about 80%, about 85%, about 90%, about 95%, about 97%, about 99%, about 100% or from about 50% to about 100% (e.g., from about 60% to about 90%, about 70% to about 99%, about 80% to about 100% or about 90% to about 100%) relative to a control (e.g., no DBH relative to DBH). An “effective amount of one or more non-steroidal ecdysone agonists” is one that achieves these reductions.

The compositions of the various embodiments of the present invention comprise various inert and active ingredients known in the art. Examples of the various ingredients contained in the compositions described herein include carriers (e.g., organic solvents, such as alkanols, such as ethanol; aromatics, such as xylenes; ketones, such as acetone; plant-derived oils, such as those derived from corncobs; and petroleum fractions), emulsifiers, stabilizers, cuticular/tarsal uptake enhancers, and cytochrome P450 inhibitors (e.g., piperonyl butoxide, 1-aminobenzotriazole, alpha-naphthoflavone, beta-naphthoflavone, apigenin, baicalein, beta-myrcene, catechin, 3-phenylpropyl acetate, formononetin, gallic acid, hesperetin, hesperidin, isoquercitrin, lauryl alcohol, luteolin, luteolin-7-glycoside, narigin, nordihydroguaiaretic acid, quercitrin, swertiamarin, terpineol, and trans-cinnamaldehyde).

Examples of cuticular/tarsal uptake enhancers include a mixture of saturated or unsaturated C₁₀-C₂₆ fatty acids (e.g., C₁₂-C₂₀, C₁₆-C₂₂, C₁₂-C₁₈, and C₁₄-C₂₂ fatty acids) and/or their corresponding C₁-C₆ alkyl esters (e.g., C₁-C₃ and C₂-C₅ alkyl esters of C₁₂-C₂₀, C₁₆-C₂₂, C₁₂-C₁₈, and C₁₄-C₂₂ fatty acids). In some embodiments, cuticular/tarsal uptake enhancers include a mixture of alkyl esters of saturated or unsaturated C₁₀-C₂₆ fatty acids (e.g., alkyl esters of C₁₂-C₂₀, C₁₆-C₂₂, C₁₂-C₁₈, and C₁₄-C₂₂ fatty acids). Cuticular/tarsal uptake enhancers also include a mixture of methyl esters of saturated or unsaturated C₁₀-C₂₆ fatty acids (e.g., alkyl esters of C₁₂-C₂₀, C₁₆-C₂₂, C₁₂-C₁₈, and C₁₄-C₂₂ fatty acids), including, for example, rapeseed methyl esther.

As used herein, the term “alkyl” includes straight, branched, and cyclic C₁-C₆ alkyl groups. Examples of straight C₁-C₆ alkyl groups include methyl, ethyl, propyl, butyl, and hexyl. Examples of branched C₁-C₆ alkyl groups include isopropyl, ter-butyl, and neopentyl. Examples of cyclic C₁-C₆ alkyl include cyclopropyl, cyclobuyl, cyclopentyl, and cycloxexyl.

As used herein, the term “non-steroidal ecdysone agonists” includes but is not limited to, diacylhydrazine derivatives that act as non-steroidal ecdysone agonist. Examples of diacylhydrazine derivatives include halofenozide, methoxyfenozide, tebufenozide, chromafenozide, fufenozide, RH5849, and KU-106. The chemical structures of these diacylhydrazine derivatives is shown herein:

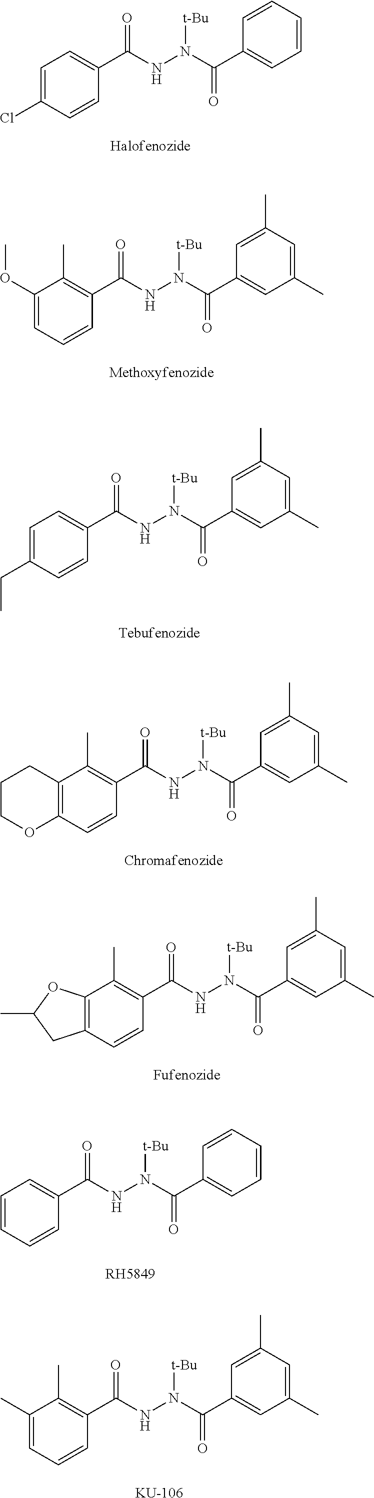

As used herein, the term “contact” and “contacting” comprise situations when any external surface on a mosquito comes in contact with the non-steroidal ecdysone agonist(s). The term “contact” and “contacting” therefore comprises contact with any surface on a mosquito, hence “topical contact,” including contact with one or more of a mosquito's head or any part thereof (e.g., proboscis, flagellomere, antennae, palps, eyes, and occiput); thorax or any part thereof (e.g., antepronotum, scutum, scutellum, postnottum, and halter); abdomen (e.g., any one or more of the abdominal segments and the cercus); wings; and legs (e.g., foreleg, including tarsomeres, tibia, and femur mid-leg; and hind-leg). In some embodiments, the topical contact comprises contact with one or both of the tarsa of the mosquito, such that the topical contacting comprises tarsal contact. In some embodiments, the tarsal contact comprises tarsal absorption of the one or more non-steroidal ecdysone agonists.

Although the methods disclosed herein encompass at least one of substantially reducing Plasmodium and/or oocyst development, substantially reducing mating success, substantially abolishing egg development after blood feeding, and substantially reducing the mean survival rate of adult, female mosquitoes, the embodiments of the invention is not so limited. In some embodiments, the methods are also generally applicable to adult, females of the order diptera, adult, female mosquitoes of other genera, and fruit flies. In some embodiments, the methods are also generally applicable to adult, female lepidopterans.

The species of mosquitoes to which the methods of the various embodiments of the present invention applicable are not limited. Examples of species of mosquitoes to which the methods of the various embodiments of the present invention apply include Anopheles spp (e.g., An. arabiensis, An. funestus and An. Stephensi), Aedes spp or Culex spp, including adult, female mosquitoes of those species.

Combinations of an effective amount of one or more non-steroidal ecdysone agonists and an effective amount of one or more insecticides that are not a non-steroidal ecdysone agonist are also contemplated herein. The one or more insecticide is not limited. Examples of insecticides include antibiotic insecticides, macrocyclic lactone insecticides (e.g., avermectin insecticides, milbemycin insecticides, and spinosyn insecticides), arsenical insecticides, botanical insecticides, carbamate insecticides (e.g., benzofuranyl methylcarbamate, dimethylcarbamate insecticides, oxime carbamate insecticides, and phenyl methylcarbamate insecticides), diamide insecticides, desiccant insecticides, dinitrophenol insecticides, fluorine insecticides, formamidine insecticides, fumigant insecticides, inorganic insecticides, insect growth regulators (e.g., chitin synthesis inhibitors, juvenile hormone mimics (e.g., hydroprene, fenoxycarb and pyriproxyfen), juvenile hormones, moulting hormone agonists, moulting hormones, moulting inhibitors, precocenes, and other unclassified insect growth regulators), nereistoxin analogue insecticides, nicotinoid insecticides (e.g., nitroguanidine insecticides, nitromethylene insecticides, and pyridylmethylamine insecticides), organochlorine insecticides, organophosphorus insecticides, oxadiazine insecticides, oxadiazolone insecticides, phthalimide insecticides, pyrazole insecticides, pyrethroid insecticides (e.g., permethrin, deltamethrin, cypermethrin, cyphenothrin, etofenprox, fenvalerate, and cyfluthrin), pyrimidinamine insecticides, pyrrole insecticides, tetramic acid insecticides, tetronic acid insecticides, thiazole insecticides, thiazolidine insecticides, thiourea insecticides, urea insecticides, as well as, other unclassified insecticides.

Some specific, non-limiting insecticides that can be used in combination with the one or more non-steroidal ecdysone agonists include 1,2-dichloropropane, 1,3-dichloropropene, abamectin, acephate, acetamiprid, acethion, acetoprole, acrinathrin, acrylonitrile, alanycarb, aldicarb, aldoxycarb, aldrin, allethrin, allosamidin, allyxycarb, alpha-cypermethrin, alpha-endosulfan, amidithion, aminocarb, amiton, amitraz, anabasine, athidathion, azadirachtin, azamethiphos, azinphos-ethyl, azinphos-methyl, azothoate, barium hexafluorosilicate, barthrin, bendiocarb, benfuracarb, bensultap, beta-cyfluthrin, beta-cypermethrin, bifenthrin, bioallethrin, bioethanomethrin, biopermethrin, bioresmethrin, bistrifluoron, borax, boric acid, boric acid, bromfenvinfos, bromocyclen, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chlorantraniliprole, chlorbicyclen, chlordane, chlordecone, chlordimeform, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, cinerin I, cinerin cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyantraniliprole, cyclethrin, cycloprothrin, cyfluthrin, cyhalothrin, cypermethrin, cyphenothrin, cyromazine, cythioate, DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diatomaceous earth, diazinon, dicapthon, dichlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinoprop, dinosam, dinotefuran, diofenolan, dioxabenzofos, dioxacarb, dioxathion, disulfoton, dithicrofos, d-limonene, DNOC, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flonicamid, flubendiamide, flucofuron, flucycloxuron, flucythrinate, flufenerim, flufenoxuron, flufenprpx, fluvalinate, fonofos, formetanate, formothion, formparanate, fosmethilan, fospirate, fosthietan, furathiocarb, furethrin, gamma-cyhalothrin, gamma-HCH, halfenprox, HCH, HEOD, heptachlor, heptenophos, heterophos, hexaflumuron, HHDN, hydramethylnon, hydrogen cyanide, hydroprene, hyquincarb, imidacloprid, imiprothrin, indoxacarb, iodomethane, IPSP, isazofos, isobenzan, isocarbophos, isodrin, isofenphos, isoprocarb, isoprothiolane, isothioate, isoxathion, ivermectin, jasmolin I, jasmolin II, jodfenphos, juvenile hormone I, juvenile hormone II, juvenile hormone III, kelevan, kinoprene, lambda-cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfenfos, metaflumizone, methacrifos, methamidophos, methidathion, methiocarb, methocrotophos, methomyl, methoprene, methoxychlor, methyl bromide, methylchloroform, methylene chloride, metofluthrin, metolcarb, metoxadiazone, mevinphos, mexacarbate, milbemectin, milbemycin oxime, mipafox, mirex, monocrotophos, morphothion, moxidectin, naftalofos, naled, naphthalene, nicotine, nifluridide, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluoron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, profenofos, profluthrin, promacyl, promecarb, propaphos, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, silica gel, sodium arsenite, sodium fluoride, sodium hexafluorosilicate, sodium thiocyanate, sophamide, spinetoram, spinosad, spiromesifen, spirotetramat, sulcofuron, sulfoxaflor, sulfluramid, sulfotep, sulfuryl fluoride, sulprofos, tau-fluvalinate, tazimcarb, TDE, tebufenpyrad, tebupirimfos, teflubenzuron, tefluthrin, temephos, TEPP, terallethrin, terbufos, tetrachloroethane, tetrachlorvinphos, tetramethrin, theta-cypermethrin, thiacloprid, thiamethoxam, thicrofos, thiocarboxime, thiocyclam, thiodicarb, thiofanox, thiometon, thiosultap, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin, zolaprofos, and α-ecdysone.

Embodiments of the present invention also include methods for substantially reducing at least one of the transmission of mosquito borne pathogens and the propensity for mosquito biting comprising: contacting adult, female mosquitoes with a composition comprising an effective amount of one or more non-steroidal ecdysone agonists. In some embodiments, the contacting causes the adult, female mosquitoes to not be able to support development of the mosquito borne pathogens.

As used herein, the term “mosquito borne pathogens” includes Plasmodium, Filarioidea-type roundworm larvae, on'yong'yong virus, dengue, yellow fever virus, West Nile virus, chikungunya virus, Eastern equine virus, Japanese encephalitis virus, Zika virus or combinations thereof.

As used herein, the term “substantially reducing the transmission of mosquito borne pathogens” generally refers to reducing the ratio of infective to non-infective adult, female mosquitoes from about 1.2 to about 0.05 (e.g., about 1.1 to about 0.1, about 0.8 to about 0.25, about 0.75 to about 0.3) relative to control (e.g., no DBH relative to DBH). An “effective amount of one or more non-steroidal ecdysone agonists” is one that achieves these reductions. For example, in a control group, the percentages of infective and non-infective adult, female mosquitoes might be 50% and 50% respectively. And in the DBH group, the percentages of infective and non-infective adult, female mosquitoes might be 7.5% and 92.5% respectively. The ratio of the percentages of infective and non-infective adult, female mosquitoes is therefore about 1. And the ratio of the percentages of infective and non-infective mosquitoes is about 0.08. The ratio of the percentages of infective and non-infective mosquitoes has therefore been reduced from about 1 to about 0.08 in the DBH group, relative to the control group.

As used herein, the term “substantially reducing the propensity for mosquito biting” generally refers to reducing the ratio of the percentages of biting of bloodfed to not bloodfed adult, female mosquitoes from about 7 to about 0.5 (e.g., about 7 to about 0.75, about 6 to about 0.5, about 5 to about 1 or about 6 to about 1.2) relative to control (e.g., no DBH relative to DBH). An “effective amount of one or more non-steroidal ecdysone agonists” is one that achieves these reductions. For example, in a control group, the percentages of biting of bloodfed and not bloodfed adult, female mosquitoes might be 86% and 14%, respectively. And in the DBH group, the percentages of biting of bloodfed and not bloodfed adult, female mosquitoes might be 29% and 71%, respectively. The ratio of the percentages of biting of bloodfed and not bloodfed adult, female mosquitoes in the control group is therefore about 6. And the ratio of the percentages of biting of bloodfed and not bloodfed adult, female mosquitoes in the DBH group is about 0.4. The ratio of the percentages of biting of bloodfed and not bloodfed adult, female mosquitoes has therefore been reduced from about 6 to about 0.4 in the DBH group, relative to the control group.

In some embodiments, the non-steroidal ecdysone agonists described herein (e.g., DBH) prevent biting by Aedes vector (e.g., Aedes aegypti), which is responsible for transmitting dengue fever, chikungunya, Zika fever and yellow fever viruses, and other diseases. Preliminary data obtained by the inventors suggests that non-steroidal ecdysone agonists (e.g., DBH) might also result in deformed eggs in Aedes species.

Other embodiments of the present invention relate to an indoor or outdoor surface wherein: the surface comprises a composition comprising an effective amount of one or more non-steroidal ecdysone agonists; the composition causes, in adult, female mosquitoes at least one of a substantial reduction in Plasmodium and/or oocyst development, a substantial reduction of mating success, substantially abolishing of egg development after blood feeding, substantial reduction in the mean survival rate of adult, female mosquitoes, a substantial reduction in the transmission of mosquito borne pathogens, and a substantial reduction in the propensity for mosquito biting.

As used herein, the term “surface” includes any surface, whether located indoor, outdoor or on a person. Surfaces include, for example, an interior or exterior wall of a building; a bed net; an indoor or outdoor fabric (e.g., hammocks, rope, curtains, pillows, pillow cases, bed sheets, bed skirts, duvet covers, place mats, napkins, window screens, etc.); clothing (e.g., hats; gloves; socks, shirts, jackets, etc.) The term “surface” also includes the surface that is inside or outside of a trap, such as an insect trap (e.g., a bait trap).

In some embodiments, the surface comprises the compositions described herein that can comprise, among other things, carriers (e.g., organic solvents, such as alkanols, such as ethanol; aromatics, such as xylenes; ketones, such as acetone; plant-derived oils, such as those derived from corncobs; and petroleum fractions), emulsifiers, stabilizers, cuticular/tarsal uptake enhancers, and cytochrome P450 inhibitors (e.g., piperonyl butoxide, 1-aminobenzotriazole, alpha-naphthoflavone, beta-naphthoflavone, apigenin, baicalein, beta-myrcene, catechin, 3-phenylpropyl acetate, formononetin, gallic acid, hesperetin, hesperidin, isoquercitrin, lauryl alcohol, luteolin, luteolin-7-glycoside, narigin, nordihydroguaiaretic acid, quercitrin, swertiamarin, terpineol, and trans-cinnamaldehyde)

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those of ordinary skill in the art, and that such modifications and variations are considered to be within the scope of this invention as defined by the appended claims.

### Examples

The following examples are included to demonstrate specific embodiments of the invention. However, many changes can be made in the specific embodiments which are disclosed and still obtain a like or similar result without departing from the spirit and scope of the invention.

### INTRODUCTION

Current malaria control and elimination programs are severely jeopardized by emerging resistance to insecticides and drugs, a lack of an effective vaccine, and a paucity of tools for mosquito control. Development of active compounds targeting the mosquito vector with novel modes of action that can be safely employed alone or together with insecticides will be essential for achieving malaria elimination goals. Informed by empirical findings described herein of the multiple effects of the 20E agonist DBH on mosquito reproduction and lifespan, the model discussed herein shows that effective malaria control and elimination can be achieved when DBH is used alone and in combination with insecticides, regardless of the mode of application. This combined synergistic effect allows for dramatic transmission reduction even at very low insecticide efficacies, a particularly relevant finding considering the degree of insecticide resistance emerging in natural mosquito populations. Moreover, when DBH application occurs at low coverage malaria elimination can be achieved whilst maintaining mosquito populations, thus minimizing the impact of DBH on ecosystem stability.

A striking impact of DBH was observed on insemination rates, egg development, and adult female longevity in experimental applications. These results are in agreement with studies linking high 20E activity to premature aging and apoptosis of ovarian follicles in the fruit fly Drosophila melanogaster, and to the loss of mating receptivity observed in An. gambiae females receiving male 20E during copulation. Interestingly, recent studies targeting another insect hormone, the sesquiterpene juvenile hormone, have shown life shortening and sterilizing activity against adult Anopheles species. Pyriproxyfen, a juvenile hormone analog is currently being tested in LLINs for its combined efficacy with insecticides. Upon optimization and testing of DBH tarsal uptake, alternating the use of DBH and pyriproxyfen alone or in combination with insecticides may provide the key to reducing infectious mosquito numbers while preventing the spread of resistance mechanisms in the population.

As DBH is not toxic to mammals unless used at extremely high concentrations and is non-carcinogenic, this compound is suitable for bed net-based strategies where low toxicity is an essential requisite, and could represent an effective alternative to the only insecticides currently used on LLINs, namely, pyrethroids. Importantly, given the multiple essential roles of the steroid hormone 20E during larval development and adult life, emergence of resistance mechanisms to DBH may be costly for the mosquito. Although instances of oxidative metabolism of DBH compounds have been observed in Lepidopteran larvae, cross-resistance to other insecticide groups has not been reported. Moreover, selective pressures may be partially relieved or completely lifted by using DBH compounds in rotation, mosaics or combination with insecticides, as these have completely different modes of action. Given the conserved role of 20E in regulating female physiology in multiple anopheline species, it is expected that DBH will be effective against effective malaria vectors such as An. arabiensis, An. funestus and An. stephensi. DBH-based approaches may therefore be pivotal for successful malaria control in Africa and other regions of the world affected by this disease.

### Methods

### Mosquito Rearing

An. gambiae mosquitoes of the G3 strain were employed in all experiments. All mosquitoes were maintained under standard insectary conditions (26-28° C., 65-80% relative humidity, 12:12 hours light/dark photoperiod).

### DBH Compound Application

The DBH compound methoxyfenozide (0.5 μl of a 0.4% solution re-suspended in acetone) (Sigma-Aldrich, 32507) was topically applied to the thorax of An. gambiae females anesthetized on ice using a micropipette. Mating success, egg development after blood feeding and longevity were determined relative to acetone-treated controls. Females were 2 days old at the time of application, and each experiment was replicated twice. The effects of methoxyfenozide on mating success were determined by adding DBH-treated and control virgin females into separate cages containing a large excess of 5 day-old virgin males, 24 hours following topical application. 48 hours later successfully inseminated (mated) females from each cage were determined via dissection and the presence of sperm in the spermatheca. To assess egg development, treated and control females were blood fed on human blood using a Hemotek membrane feeding system 24 hours after DBH application, as 20E strongly inhibits biting behavior. Egg development was evaluated 3 days later upon dissection of the ovaries.

For the longevity experiments, DBH-treated and control females were maintained in cups and supplied ad libitum with a 10% sucrose solution and water. Mortality rates after DBH/acetone exposure were recorded daily for 2 weeks, encompassing the period needed for mosquitoes to become infectious.

### Mathematical Modeling Methods

Anopheles Population Dynamic Model

A discrete-time deterministic mathematical model of mosquito population dynamics was developed to examine the impact of DBH on its own on Anopheles mosquitoes and/or in the presence of insecticide. Parameter values for the different effects of DBH (e.g., mating, egg development, and mortality) were determined from experimental results, as described herein in the section entitled “Estimation of DBH efficacy from data,” while other parameter values were taken from the literature (Table 1) or are discussed herein. This framework was extended to include malaria transmission and feedback between human and mosquito populations to estimate the impact of DBH on malaria.

The impact of DBH on its own was explicitly modeled, either delivered via DBH-impregnated bed nets to target females as they attempt to blood feed, or in DBH indoor sprays to target females as they rest after feeding, in both high (with 65% malaria prevalence pre-intervention) and low (with 5% malaria prevalence pre-intervention) transmission settings and with varying levels of coverage, e.g., the percentage of the human population protected by DBH and/or insecticide. To quantitatively examine the relative efficacy and general mechanisms of transmission reduction following a DBH-based intervention, a single well-mixed mosquito population without spatial structure was used.

In the model of the An. gambiae lifecycle described herein, adult mosquitoes lay eggs, which spend three days as eggs and ten days as larvae, a period combining both the morphological larval and pupal stages. Only female adult mosquitoes are modeled although male eggs and larvae remain to appropriately account for density dependence during the larval stage. Upon emerging as adults, females rest before either mating or feeding, and those who feed as virgins but do not encounter DBH, subsequently mate. An excess of males was assumed such that every female can successfully mate. Upon mating, females enter repeated gonotrophic cycles consisting of: (i) feeding, (ii) resting for two days to promote digestion and egg development, and (iii) egg laying. Each activity takes place in the evening and mosquitoes engage in a single activity per day, the time step in the model. A proportion of mosquitoes are lost to mortality each day, at rates that differ for eggs, larvae and adults. The daily mortality rate for eggs assumes that approximately half (˜51%) of eggs hatch after 3 days, below the estimated hatch rate in controlled laboratory conditions to account for predation. While the daily mortality rates for eggs and adults are fixed, density dependence in larval mortality was incorporated as a sigmoidal increase with the larval population size:

$${\tilde{d}}_{l} ( {n}_{l} ) = {d}_{l} - {c}_{1} + \frac{1 - ( {d}_{l} - {c}_{1} )}{1 + {e}^{- {c}_{2} ( {n}_{l} / K ) + {c}_{3}}}$$

where d₁=0.2 is the baseline daily larval mortality rate, n₁ is the total number of larvae, K=10 is the carrying capacity of the larval population, and the shape of the function is determined by the constants, c₁=0.0146, c₂=2, c₃=4 found in S1 Text. After four gonotrophic cycles at the baseline mortality rate, the proportion of the mosquito population remaining is small and is removed, yielding a maximum lifespan of 19 days.

The mating effect prevents virgin mosquitoes from mating with probability hₘ, although exposed virgin feeders, which cannot produce viable eggs, still enter gonotrophic cycles, contributing to the spread of malaria through biting behavior. The egg effect reduces egg batch size by a factor hₑ. The mortality effect increases mortality for adult mosquitoes as follows:

d′ₐ=dₐ+h_{d}−dₐh_{d}.

with enhanced mortality for the remainder of the mosquitoes' lifespan, at a variable rate described herein in the section entitled “Estimation of DBH efficacy from data.”

Similar to application of DBH, insecticide exposure occurs while feeding to simulate LLINs, and while resting to simulate IRS, and results in death with a proportion d_{c} of mosquitoes killed, reflecting the insecticide efficacy of 80%, i.e. initial stages of insecticide resistance in the population. Mosquitoes that survive have no lasting effects. Overall adult mortality, taking into account both the mortality effect of DBH and insecticide, is then calculated as the proportion of mosquitoes dying due to at least one of three cases: natural causes, DBH or insecticide.

$$\begin{matrix}{d}_{a}^{″} = {d}_{a}^{′} + {d}_{c} ( 1 - {d}_{a}^{′} ) \\ = {d}_{a} d + {h}_{d} + {d}_{c} - ( {h}_{d} {d}_{a} + {d}_{c} {d}_{a} + {d}_{c} {h}_{d} ) + {h}_{d} {d}_{a} {d}_{c} .\end{matrix}$$

Incorporating Malaria Transmission

To examine the impact of DBH on malaria transmission, susceptible and infectious human populations were added to the mosquito lifecycle model. The infectious human proportion:

I_{H}(t+1)=βₕ(t)S_{H}(t)−νI_{H}(t)

depends on

βₕ(t)=1−(1−b)^{N×f(t)}

the daily risk of becoming infected, and ν=1/D, the daily recovery rate, where b is the probability of infection given a bite and f(t) is the number of infectious feeders on day t.

Mosquitoes are infected in the model by feeding on an infectious human host. For a feeding mosquito, the risk of becoming infected, βₘ(t), is assumed to be linearly related to proportion of infectious humans and is capped at 1: βₘ(t)=min(kI_{H}(t),1). In each potentially infectious compartment (i.e. occurring at least 12 days after the first feeding compartment⁹), the proportion of mosquitoes that are infectious is the probability of infection during one or more earlier feeds times the number of mosquitoes, summed to find the total number of infectious feeders f(t) from all potentially infectious compartments. Interventions were considered in settings with high (65%) or low (5%) malaria prevalence, mediated by the rate of bites per human per mosquito per day.

Estimation of DBH Efficacy from Data

A mating effect experiment was comprised of an unexposed and exposed group with cases defined as those who mated. The efficacy of the mating effect was defined as the prevented fraction in exposed, i.e. one minus the risk ratio. The egg effect experiment considered unexposed and exposed groups with cases defined as those who developed eggs. As zero counts existed, add-one smoothing was employed, i.e. for the unexposed group one was added to the number of cases and for the exposed group one was added to the number of non-cases, and the risk of egg development was then estimated in both groups. As with the mating effect, the efficacy of the egg effect was defined as the prevented fraction in exposed.

Day post-exposure was stratified to account for the time varying nature in the mortality effect experiment. For each day, there is the number of exposed and unexposed mosquitoes surviving to that day (risk set), and the number in each group surviving through that day. Using the risk set in day i, the relative risk of surviving through day i (RRᵢ) is estimated, comparing the exposed to the unexposed. The efficacy for the mortality was defined as one minus RRᵢ for day i. The confidence interval for the relative risk of survival was estimated using a Normal approximation of ln(RRᵢ), with standard error:

$$SE ( ln ( {RR}_{i} ) ) = \sqrt{\frac{{a}_{i}}{{a}_{i} ( {a}_{i} + {b}_{i} )} + \frac{{d}_{i}}{{c}_{i} ( {c}_{i} + {d}_{i} )}}$$

where aᵢ, bᵢ are the number of survivors and fatalities in the exposed group for day i, and cᵢ, dᵢ analogously for the unexposed group. Statistical analyses were done using Stata 11.2.

Topical Application of DBH (Methoxyfenozide) to an. Gambiae Females Affects Key Parameters of Vectorial Capacity

To determine if 20E agonists can be used to manipulate entomological parameters key to successful malaria transmission, An. gambiae females were treated with DBH and assessed its effects on mating success and egg development post blood feeding, two reproductive traits that impact the size of mosquito populations and hence the frequency of mosquito encounters with the human host. As 20E injections in virgin females completely abolish insemination in a number of Anopheles species, it was reasoned that topical application of DBH to the female's thorax might achieve the same result. Moreover, although 20E is essential for egg development, levels above a critical threshold can induce apoptosis of ovarian follicles and this effect may be recapitulated by DBH treatment. A possible effect of DBH application on female mortality was also determined, as 20E is known to regulate longevity and a long lifespan is crucial to malaria transmission given the Plasmodium sporogonic cycle takes 12-14 days to complete.

Mating success, egg development and lifespan were all significantly altered in An. gambiae females by DBH treatment. Only 29% of females treated once with DBH were successfully inseminated by males, as determined by the presence of sperm in the spermatheca, compared to 86% of controls (Fisher's exact text, p<0.0001). Furthermore, egg development was completely abolished in these females after blood feeding, whereas oogenesis was fully successful in controls (Fisher's exact text, p<0.0001). Finally, DBH-treated females showed significantly increased mortality, with a median survival time of 8 days and nearly 100% mortality over 14 days, compared to only 10% mortality detected in controls over the same period (Log-rank test, p<0.0001). These combined effects demonstrate a strong impact of DBH application on mosquito survival and reproductive success, with possible consequences for malaria transmission.

Dose Dependency Experiments

Egg laying, mating, and lifespan were all significantly altered in a DBH dose-dependent manner. Mated females were tested for their ability to develop and lay eggs when exposed to DBH 24 hours prior to blood feeding at 5 different doses ranging in a 2-fold dilution series from about 2 μg to about 0.125 μg per mosquito, respectively. One hundred percent (100%) of the control females oviposited after a blood meal. Females exposed to DBH showed a dose-dependent reduction in oviposition, with 47.4% of individuals laying eggs at the median dose (0.5 μg) and only 10.9% at the highest dose (2 μg). An ED₅₀ dose of 0.5 μg (0.08-0.13 95% CI) was determined from the dose-response curve (slope of 2.32, R=0.993). Moreover, even in cases where females oviposited, a significant reduction in the number of eggs laid was detected at the three highest doses (e.g., 2 μg; 1 μg; and 0.5 μg), with a median egg number of zero compared to a median of 91.5 eggs in the control group. Upon dissection of individuals in all DBH-exposed groups, 98.7% of females were found to have no eggs developed in the ovaries despite fully engorging on blood.

While not wishing to be bound by any specific theory, these results appear to demonstrate that the reduction in oviposition rates may be due to impaired oogenesis. Induction of autogenous egg development after exposure was not observed. Microscopic analysis of ovaries after terminal deoxynucleotidyl transferase dUTP nick end labeling (TUNEL) assays detected extensive fragmentation of chromatin, indicative of apoptosis, limited to the primary ovarian follicles of treated females 24 hours after DBH exposure, while control females had no observable apoptosis and had otherwise normal follicular morphology. Similar apoptotic follicles were observed after 20E injections, showing that the phenotype induced by DBH application recapitulates the effects induced by 20E.

Mating and female longevity were also significantly reduced in a dose-dependent manner compared to controls as a result of DBH exposure. After treating virgin females with 3 DBH doses (2 μg (high), 0.5 μg (median), and 0.125 μg (low), corresponding to approximately ED₉₀, ED₅₀ and ED₁₀)) and placing them with males for 2 days, a 65-25% reduction in insemination rates, as determined by the presence of sperm in the spermatheca was observed.

In addition, DBH-treated females showed an eight-day reduction in median survival time at the highest dose compared to controls (median survival time in 2 μg DBH: 11 days; Control: 19 days), and lifespan was reduced even at the lowest dose (median survival time in 0.125 μg DBH: 16 days). P. falciparum prevalence (NF54 strain) was significantly reduced 7 days post-infectious blood meal at the two higher DBH doses relative to the control. At the highest dose (2 μg), only 7.5% of females who fully engorged on an infectious blood meal were positive for oocysts, corresponding to an 87% reduction in infection prevalence relative to controls. When using the median dose (0.5 μg), 25.8% of females failed to develop an infection, providing a 56% reduction in prevalence. Limited effects were observed in the low dose treatment group (0.125 μg), where oocyst prevalence (50.7%) was similar to the control group (58.5%). In those females that developed oocysts, the intensity of infection was not significantly affected. While not wishing to be bound by any specific theory, these results appear to demonstrate a strong, dose-dependent effect of DBH on four important determinants of vectorial capacity which in turn may be an indication that DBH exposure affects adult, female mosquitoes in a predictable and reproducible manner.

Modeling the Impact of DBH on Mosquito Populations Predicts a Dramatic Shift Towards Younger Females

A discrete-time deterministic mathematical model of the mosquito life cycle was developed to predict the impact of DBH on Anopheles population dynamics. Individual mosquitoes were modeled through their life cycle, starting with the development of juvenile aquatic stages (eggs and larvae), followed by mating and four gonotrophic cycles consisting of feeding, resting and ovipositing. Experimental findings were used to define the efficacy of DBH and included the three effects of DBH in the model as follows: reduced mating success (67% reduction, with 68% CI of 58-73% reduction), impaired egg development (98% reduction, with 68% CI of 94-99% reduction), and enhanced daily mortality rate (with maximum 60% increase in mortality at day 8 post exposure, with 68% CI of 37-72% increased mortality).

The impact of DBH was explicitly modeled on its own, either delivered via DBH-impregnated bed nets to target females as they attempt to blood feed, or in DBH indoor sprays to target females as they rest after feeding. In addition, the application of DBH was considered in combination with insecticides, to examine the possible synergistic impact of incorporating DBH in LLINs or IRS in both high (with 65% malaria prevalence pre-intervention) and low (with 5% malaria prevalence pre-intervention) transmission settings. Varying levels of coverage were examined, e.g., the percentage of the human population protected by DBH and/or insecticide, as 100% coverage is unlikely to be achieved in most field settings due to factors such as isolation of human populations and lack of resources. A single well-mixed mosquito population without spatial structure was used to quantitatively examine the relative efficacy and general mechanisms of transmission reduction following a DBH-based intervention.

The modeled mosquito population and its composition were significantly altered under the application of DBH. The total adult mosquito population increased at low coverage, driven by reduced density-dependent larval mortality, but coverage above 30% resulted in a dramatic decrease in population size due to increased adult mortality and reduced egg batch sizes, with extinction occurring above 50% coverage. This non-linear relationship between DBH coverage and adult population size was accompanied by a dramatic shift in the age distribution of adult females towards younger individuals. Importantly, even when adult mosquito populations increased, as in the case of DBH coverage below 30%, the relative proportion of adults that could potentially transmit malaria (females over 12 days old) was reduced at all levels of coverage compared to no intervention. This maintenance of overall mosquito numbers at low coverage may minimize the ecological impact of DBH.

When DBH was applied in combination with insecticide, adult mosquito populations were rapidly driven to extinction even at coverage as low as 35%. Exposure through indoor spraying showed similar effects on the mosquito population including the age shift of the population. To determine how each individual effect produced by DBH exposure (e.g., mating success, egg development and mortality) alters the mosquito population, these effects were also considered independently in the model.

DBH is Predicted to Achieve Malaria Elimination Alone or in Combination with Insecticides

The mathematical framework was extended to include malaria transmission and feedback between infectious human and mosquito populations to estimate the impact of DBH on malaria. For simplicity, the human population using a susceptible-infectious framework was modeled. Mosquitoes could acquire infection upon feeding, and required 12 days to become infectious to humans. The reduction in adult population size due to DBH exposure, coupled with the predicted decline in older adult mosquitoes, dramatically reduced the prevalence of malaria. DBH alone had a similar impact to insecticide in the model described herein, with elimination being achieved when coverage was above 40%. In combination with insecticide, however, even modest bed net coverage of 25% led to elimination. Furthermore, elimination was more frequently attained, and was achieved more rapidly, when DBH and insecticides were used in combination. Similar dynamics were observed when modeling DBH use in indoor sprays. How each individual effect of DBH altered malaria prevalence when applied via bed nets was also examined. In low transmission settings, elimination was achieved at any coverage above 15%.

Equilibrium prevalence and time to elimination were affected at varying levels of coverage and for different degrees of DBH and insecticide efficacy. DBH alone had a similar impact as insecticide on malaria transmission. However, DBH in combination with even weakly effective insecticides (as low as 10% efficacy) and at relatively low coverage of bed nets (as low as 40%) were sufficient to eliminate malaria using the empirically determined DBH efficacy. With a coverage above 50%, malaria was predicted to be driven to elimination within six months regardless of the insecticide efficacy and method of application. A well-mixed, simple model was used in order to examine the relative efficacy of interventions. In the field, spatial heterogeneities are expected and multitude of mosquito species to play an important role in determining the precise outcome of control programs.

1. A method for at least one of substantially reducing Plasmodium and/or oocyst development, substantially reducing mating success, substantially abolishing egg development after blood feeding, and substantially reducing the mean survival rate of adult, female mosquitoes, the method comprising:
contacting the adult, female mosquitoes with a composition comprising an effective amount of one or more non-steroidal ecdysone agonists.

2. The method of claim 1, wherein the one or more non-steroidal ecdysone agonists is at least one diacylhydrazine derivative non-steroidal ecdysone agonist.

3. The method of claim 1, wherein the one or more non-steroidal ecdysone agonist is at least one of halofenozide, methoxyfenozide, tebufenozide, chromafenozide, fufenozide, RH5849, and KU-106.

4. The method of claim 1, wherein the contacting comprises topical contacting.

5. The method of claim 4, wherein the topical contacting comprises tarsal contact.

6. The method of claim 5, wherein the tarsal contact comprises tarsal absorption of the one or more non-steroidal ecdysone agonists.

7. The method of claim 1, wherein the adult, female mosquitoes comprise Anopheles spp, Aedes spp or Culex spp.

8. The method of claim 1, wherein the substantially reducing mating success comprises a substantial reduction in number of eggs produced by the adult, female mosquitoes or a substantial reduction in the success of insemination of the adult, female mosquitoes.

9. The method of claim 1, wherein the composition comprising an effective amount of one or more non-steroidal ecdysone agonists further comprises an insecticide that is not a non-steroidal ecdysone agonist.

10. The method of claim 9, wherein the insecticide is pyrethroid, a carbamate, an organophosphate or a juvenile hormone analog.

11. The method of claim 10, wherein the insecticide comprises permethrin, bendiocarb, pirimiphos-methyl, pyriproxyfen or combinations thereof.

12. A method for substantially reducing at least one of the transmission of mosquito borne pathogens and the propensity for mosquito biting comprising: contacting adult, female mosquitoes with a composition comprising an effective amount of one or more non-steroidal ecdysone agonists.

13. The method of claim 12, wherein the mosquito borne pathogens comprises Plasmodium, Filarioidea-type roundworm larvae, on'yong'yong virus, dengue, yellow fever virus, West Nile virus, chikungunya virus, Eastern equine virus, Japanese encephalitis virus, Zika virus or combinations thereof.

14. The method of claim 12, wherein the contacting causes the adult, female mosquitoes to not be able to support development of the mosquito borne pathogens.

15. The method of claim 1, wherein the composition further comprises at least one of a cuticular/tarsal uptake enhancer and a cytochrome P450 inhibitor.

16. The method of claim 15, wherein the cuticular/tarsal uptake enhancer comprises a mixture of the methyl esters of saturated and unsaturated C₁₀-C₂₆ fatty acids.

17. The method of claim 15, wherein the cuticular/tarsal uptake enhancer comprises rapeseed methyl esther.

18. The method of claim 15, wherein the cytochrome p450 inhibitor is at least one of piperonyl butoxide and 1-aminobenzotriazole.

19. An indoor or outdoor surface wherein:
(a) the surface comprises a composition comprising an effective amount of one or more non-steroidal ecdysone agonists;
(b) the composition causes, in adult, female mosquitoes at least one of a substantial reduction in Plasmodium and/or oocyst development, a substantial reduction of mating success, substantially abolishing of egg development after blood feeding, substantial reduction in the mean survival rate of adult, female mosquitoes, a substantial reduction in the transmission of mosquito borne pathogens, and a substantial reduction in the propensity for mosquito biting.

20. The surface of claim 19, wherein the surface is at least one of an interior or exterior wall of a building; a bed net; an indoor or outdoor fabric; and clothing.

21. The surface of claim 19, wherein the surface is inside or outside of a trap.

22. The surface of claim 21, wherein the trap is a bait trap.

23. The surface of claim 19, wherein the composition further comprises at least one of a cuticular/tarsal uptake enhancer and a cytochrome P450 inhibitor.

24. The surface of claim 23, wherein the cuticular/tarsal uptake enhancer comprises a mixture of methyl esters of saturated and unsaturated C₁₀-C₂₆ fatty acids.

25. The surface of claim 23, wherein the cuticular/tarsal uptake enhancer comprises rapeseed methyl esther.

26. The surface of claim 23, wherein the cytochrome P450 inhibitor is at least one of piperonyl butoxide and 1-aminobenzotriazole.
